(19) United States
(12) Patent Application Publication
(10) Pub. No.: US 2007/0189407 A1
(43) Pub. Date: Aug. 16, 2007

(54) Demodulation system

(75) Inventor: Tsuyoshi Atsumi, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd.

(21) Appl. No.: 11/704,961

(22) Filed: Feb. 12, 2007

(30) Foreign Application Priority Data
Feb. 14, 2006 (JP) 2006-036157

(51) Int. Cl. H04K 1/10

(52) U.S. Cl. 375/260

(57) ABSTRACT

The present invention provides a modulation system that accurately demodulates a phase-demodulated signal without being affected by a phase error in received signal. In the modulation system, a sine wave generating unit of a sine wave/cosine wave generator, which generates a cosine wave and a sine wave both used for demodulating a QPSK signal, is configured so as to be capable of correcting a phase difference in accordance with a correction value. There is further provided a phase correction unit that generates the correction value equivalent to a phase error between an inphase component and an antiphase component obtained by demodulation based on the cosine wave and the sine wave. A phase correction for the sine wave can be carried out by setting an initial value of the sine wave generating unit constituted of an IIR filter to the correction value.

### BACKGROUND OF THE INVENTION

The present invention relates to a demodulation system which demodulates a phase-modulated signal such as QPSK (quadrature phase modulation).

FIG. 2 is a block diagram of a conventional demodulation system.

The present demodulation system modulates orthogonal carriers with first and second data signals respectively, and receives and demodulates a combined QPSK signal. The demodulation system includes a high-frequency unit (RF) 2 which amplifies a high-frequency signal received by an antenna 1 and a frequency converter 4 which converts the high-frequency signal amplified by the high-frequency unit 2 into an intermediate frequency in accordance with an oscillation signal of a VCO (Voltage-Controlled Oscillator) 3. The demodulation system also includes a BPF (Band-Pass Filter) 5 which extracts a desired intermediate frequency from the signal converted by the frequency converter 4 and an ADC (Analog-to-Digital Converter) 6 which converts the intermediate frequency extracted by the BPF 5 into a digital signal.

Further, the demodulation system has two multipliers 7i and 7q for separating the digital signal outputted from the ADC 6 into, components I and Q orthogonal to each other and demodulating the same, and a sine wave/cosine wave generator 8 which generates a cosine wave cos and a sine wave sin to be supplied to the multipliers 7i and 7q respectively. LPFs (Low-Pass Filters) 9i and 9q, an adder 10 which combines or synthesizes signals outputted from the LPFs 9i and 9q, and a decoder 11 which effects an error correction or the like on a signal outputted from the adder 10 to thereby output a demodulated signal OUT, are provided on the output sides of the multipliers 7i and 7q.

In the demodulation system, the high-frequency signal received by the antenna 1 is amplified by the high-frequency unit 2, followed by being frequency-converted by the frequency converter 4 in accordance with the oscillation signal outputted from the VCO 3. Then, the desired intermediate frequency is extracted by the BPF 5, followed by being converted into the digital signal by the ADC 6. The digital signal outputted from the ADC 6 is commonly supplied to the two multipliers 7i and 7q.

The multiplier 7i multiplies the digital signal by the cosine wave cos outputted from the sine wave/cosine wave generator 8. The result of multiplication is outputted from the LPF 9i as an inphase component I. The multiplier 7q multiplies the digital signal by the sine wave sin outputted from the sine wave/cosine wave generator 8. The result of multiplication is outputted from the LPF 9q as an antiphase component Q. These inphase and antiphase components I and Q are combined or synthesized at the adder 10. The result of combination is supplied to the decoder 11 from which the corresponding demodulated signal OUT is outputted.

The above prior art refers to a patent document 1 (Japanese Unexamined Patent Publication No. Hei 6(1994)-85859).

The patent document 1 describes a burst demodulation device wherein an analog-to-digital converter sample-quantizes a burst mode modulated wave detected from a digital phase-modulated burst receive signal by a semi-synchronous detector, carrier estimating means estimates a carrier with respect to sample-point data signals all stored temporarily in a buffer memory every burst, interpolation timing generating means performs an arithmetic operation on the data signals corrected in frequency and phase to estimate Nyquist points, thereby producing interpolation timings, and data correcting means effects an interpolation operation on the corrected data signals to estimate Nyquist point data, thereby generating a tentative demodulated data sequence. In the burst demodulation device, timing determining means compares and determines values obtained by accumulating and adding absolute values or absolute square values of the amplitudes of respective tentative demodulated data every burst, and data determining means determines a selected demodulated data sequence and outputs it as a demodulated data signal, thereby making it possible to reduce the load without degrading the accuracy of estimation and cope with high speed transmission.

The demodulation system is however accompanied by the following problem.

That is, the phase of a received signal varies depending upon a radio propagation path and a group delay in the system in wireless communications. Therefore, the difference in phase between the inphase component I and the antiphase component Q contained in the signal converted into the digital signal by the ADC 6 of the demodulation system causes a slight deviation or shift without reaching 90° accurately. Thus, a problem arises in that when the cosine wave cos and the sine wave sin at which the phase difference is accurately set to 90°, are generated by the sine wave/cosine wave generator 8 and supplied to the multipliers 7i and 7q, an error in demodulation occurs due to a phase error in the received signal.

### SUMMARY OF THE INVENTION

The present invention aims to provide a demodulation system capable of accurately demodulating a phase-modulated signal without being affected by a phase error in received signal.

According to one aspect of the present invention, for attaining the above object, there is provided a demodulation system that modulates orthogonal carriers with first and second data signals respectively and demodulates a combined phase-modulated signal, which comprises carrier generating means that generates first and second demodulating carriers identical in frequency to the carriers and controlled in phase difference according to a correction value in order to demodulate the phase-modulated signal, first demodulating means that multiplies the phase-modulated signal by the first demodulating carrier to demodulate an inphase component, second demodulating means that multiplies the phase-modulated signal by the second demodulating carrier to demodulate an antiphase component, and phase correcting means that generates the correction value equivalent to a phase error received from each of a propagation path and an internal circuit, based the inphase component and the antiphase component and supplies the same to the carrier generating means.

The present invention includes the phase correcting means which generates the correction value equivalent to the phase error in the inphase component demodulated by the first demodulating means or the antiphase component demodulated by the second demodulating means, and the carrier generating means which generates the first and second demodulating carriers controlled in phase difference according to the correction value. Thus, advantageous effects are brought about in that the demodulated inphase component or antiphase component is controlled such that the phase error approaches zero, and the phase-modulated signal can accurately be demodulated without being affected by the phase error in received signal.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram of a demodulation system showing one embodiment of the present invention;

FIG. 2 is a block diagram of a conventional demodulation system; and

FIG. 3 is a block diagram of a demodulation system illustrating a modification of the present invention.

### DETAILED DESCRIPTION OF THE PREFERRED EMBODIMENTS

Providing control means for decoding first and second data signals from inphase and antiphase components and stopping the operation of phase correcting means when error rates of the decoded first and second data signals reach a reference value or less makes it possible to suppress needless operations and provide a stabler demodulating operation.

The above and other objects and novel features of the present invention will become more completely apparent from the following descriptions of preferred embodiments when the same is read with reference to the accompanying drawings. The drawings, however, are for the purpose of illustration only and by no means limitative of the invention.

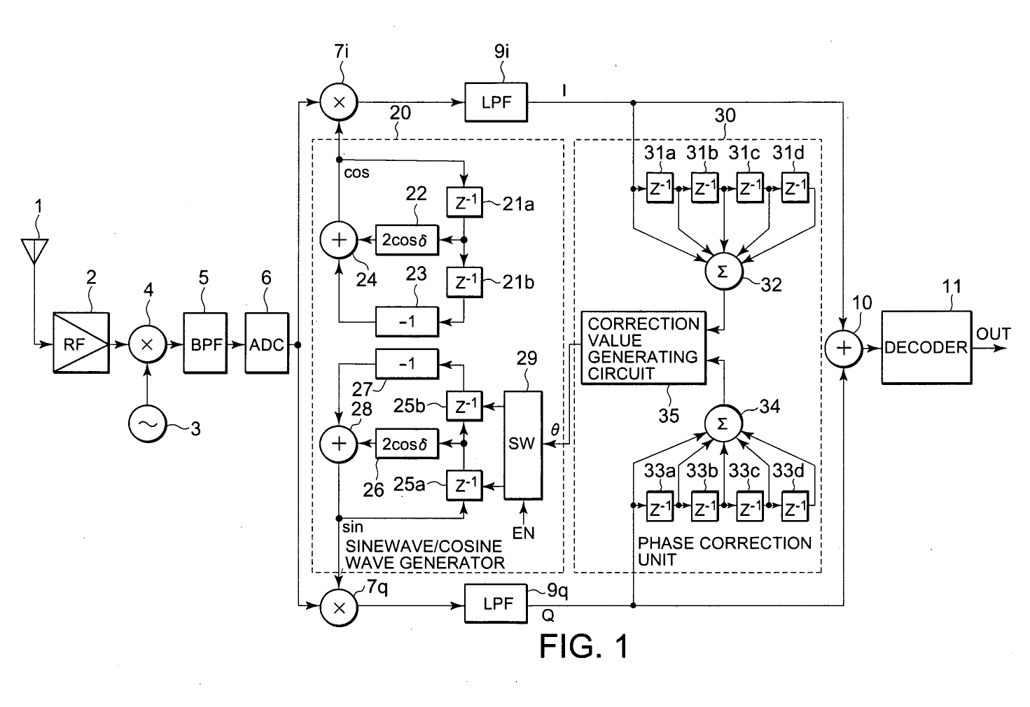

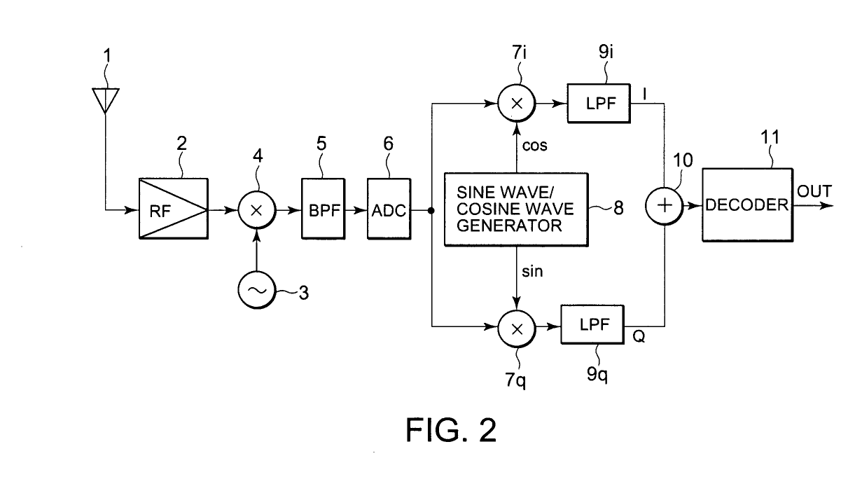

FIG. 1 is a block diagram of a demodulation system showing one embodiment of the present invention. Constituent elements common to those shown in FIG. 2 are given common reference numerals respectively.

The present modulation system receives a QPSK signal therein and demodulates the same. The modulation system includes a high-frequency unit 2 which amplifies a high-frequency signal received by an antenna 1, a frequency converter 4 which converts the high-frequency signal amplified by the high-frequency unit 2 into an intermediate frequency in accordance with an oscillation signal of a VCO 3, a BPF 5 which extracts a desired intermediate frequency from the signal converted by the frequency converter 4, an ADC 6 which converts the intermediate frequency extracted by the BPF 5 into a digital signal, and multipliers 7i and 7q each corresponding to demodulating means, which respectively separate the digital signal outputted from the ADC 6 into an inphase component I and an antiphase component Q orthogonal to each other and demodulate the same. LPFs 9i and 9q for respectively removing harmonic components to fetch or take out baseband signals, an adder 10 which combines or synthesizes the signals outputted from the LPFs 9i and 9q, and a decoder 11 which effects an error correction or the like on a signal outputted from the adder 10 to thereby output a demodulated signal OUT, are provided on the output sides of the multipliers 7i and 7q.

Further, the demodulation system includes a sine wave/cosine wave generator 20 corresponding to carrier generating means, which generates a cosine wave cos and a sine wave sin for demodulation to be supplied to the multipliers 7i and 7q, and a phase correction unit 30 corresponding to phase correcting means, which corrects the phase of the sine wave sin generated at the sine wave/cosine wave generator 20.

The sine wave/cosine wave generator 20 includes a cosine wave generating unit constituted of an IIR (Infinite Impulse Response) filter, and a sine wave generating unit constituted of the same IIR filter and capable of setting an initial value. The cosine wave generating unit comprises shift registers of two stages 21a and 21b, a 2 cosδ multiplier 22, −1 multiplier 23 and an adder 24. The output of the first-stage shift register 21a is multiplied by 2 cosδ by means of the 2 cosδ multiplier 22. The output of the second-stage shift register 21b is multiplied by −1 by means of the −1 multiplier 23. The outputs of these multipliers 22 and 23 are added together by the adder 24. The result of addition is fed back to the input side of the shift register 21a and outputted from the adder 24 as the cosine wave cos.

On the other hand, the sine wave generating unit comprises shift registers of two stages 25a and 25b each capable of setting an initial value, a 2 cosδ multiplier 26, a −1 multiplier 27, an adder 28 and a switch 29. The output of the first-stage shift register 25a is multiplied by 2 cosδ by means of the 2 cosδ multiplier 26, and the output of the second-stage shift register 25b is multiplied by −1 by means of the −1 multiplier 27. The outputs of these multipliers 26 and 27 are added together by the adder 28 from which the result of addition is fed back to the input side of the shift register 25a.

When the switch 29 is closed by an enable signal EN, the shift registers 25a and 25b are capable of setting a correction value θ outputted from the phase correction unit 30 as an initial value via the switch (SW) 29. Thus, a sine wave sin phase-corrected based on the correction value θ is outputted from the adder 28. Incidentally, the enable signal EN is given only once every one cycle from an unillustrated control circuit for simplicity of processing.

The phase correction unit 30 generates a correction value θ indicative of a shift in phase (phase shift relative to a phase difference 90° in the case of QPSK) between the inphase component I and the antiphase component Q subsequent to demodulation, which are outputted from the LPFs 9i and 9q, based on the inphase and antiphase components I and Q and supplies the same to the sine wave/cosine wave generator 20.

The phase correction unit 30 comprises an inphase average circuit which calculates a moving average value Avi of the inphase component I by a quaternary FIR (Finite Impulse Response) filter constituted of shift registers 31a through 31d and an adder 32, an antiphase average circuit which calculates a moving average value Avq of the antiphase component Q by a quaternary FIR constituted of shift registers 33a through 33d and an adder 34, and a correction value generating circuit 35 which outputs a phase shift in demodulating carrier as a correction value θ, based on the two moving averages Avi and Avq. The correction value generating circuit 35 outputs θ [rad] corresponding to tanθ=Avi/Avq. The correction value generating circuit 35 is constituted of, for example, a ROM (Read-Only Memory) which stores the value of tan⁻¹(Avi/Avq) at its corresponding address (Avi, Avq).

Incidentally, although not shown in FIG. 1, the operations in a steady state, of the digital circuits subsequent to the ADC 6 are carried out in sync with a clock signal extracted from each of the inphase component I and the antiphase component Q demodulated and outputted from the LPFs 9i and 9q.

The operation of the present demodulation system will next be explained.

A high-frequency signal received by the antenna 1 is amplified by the high-frequency unit 2 and thereafter frequency-converted by the frequency converter 4 in accordance with an oscillation signal outputted from the VCO 3. Then, the BPF 5 extracts a desired intermediate frequency and the ADC 6 converts the same into a digital signal. The digital signal outputted from the ADC 6 is commonly supplied to the multipliers 7i and 7q.

The multiplier 7i multiplies the digital signal by a cosine wave cos outputted from the sine wave/cosine wave generator 20. The result of multiplication is outputted from the LPF 9i as an inphase component I. The multiplier 7q multiplies the digital signal by a sine wave sin outputted from the sine wave/cosine wave generator 20. The result of multiplication is outputted from the LPF 9q as an antiphase component Q. These inphase component I and antiphase component Q are supplied to the phase correction unit 30 and the adder 10.

The phase correction unit 30 calculates moving average values Avi and Avq, based on the phase component I and the antiphase component Q respectively and generates a correction value θ, based on the moving average values Avi and Avq. The correction value θ generated by the phase correction unit 30 is supplied to the sine wave/cosine wave generator 20. Thus, the phase of the sine wave sin generated from the sine wave/cosine wave generator 20 is corrected based on the correction value θ, and the phase of the antiphase component Q outputted from the multiplier 7q and the LPF 9q is corrected by the correction value θ. This feedback finally eliminates a phase error.

The phase error-free inphase and antiphase components I and Q are combined together by the adder 10 and the result of combination is supplied to the decoder 11 from which a demodulated signal OUT is outputted.

As described above, the demodulation system according to the present embodiment includes the phase correction unit 30 which generates the correction value θ for correcting the phase error, based on the demodulated inphase component I and antiphase component Q, and the sine wave/cosine wave generator 20 which generates the demodulating carrier (sine wave sin in this case) whose phase is corrected in accordance with the correction value θ. Thus, the demodulation system has the advantage that a phase-modulated signal can accurately be demodulated without being affected by a phase error in received signal.

Incidentally, the present invention is not limited to the one embodiment referred to above. Various modifications can be made. As the modifications, may be mentioned, for example, such ones as described below.

(1) The configurations of the sine wave/cosine wave generator 20 and the phase correction unit 30 are illustrated by way of example. If such ones as to have similar functions are adopted, then they can be applied in like manner.

(2) Although the illustrated circuit takes the circuit configuration based on the digital processing, it can similarly be applied even to a circuit based on analog processing.

(3) The present invention can similarly be applied not only to QPSK but also to other phase-modulated signals (such as 16 QAM, 64 QAM, etc.)

(4) Although the sine wave/cosine wave generator 20 performs the phase correction in accordance with the enable signal EN supplied every one cycle from the unillustrated control circuit, for example, the control circuit may be configured so as to determine the value of the correction value θ and output the enable signal EN only when an error exceeds a reference value.

(5) The modulation system may be configured in such a manner that when the frequency (error rate) of error correction has reached a reference value or less, the operation of the phase correction unit 30 is stopped by control means such as the control circuit.

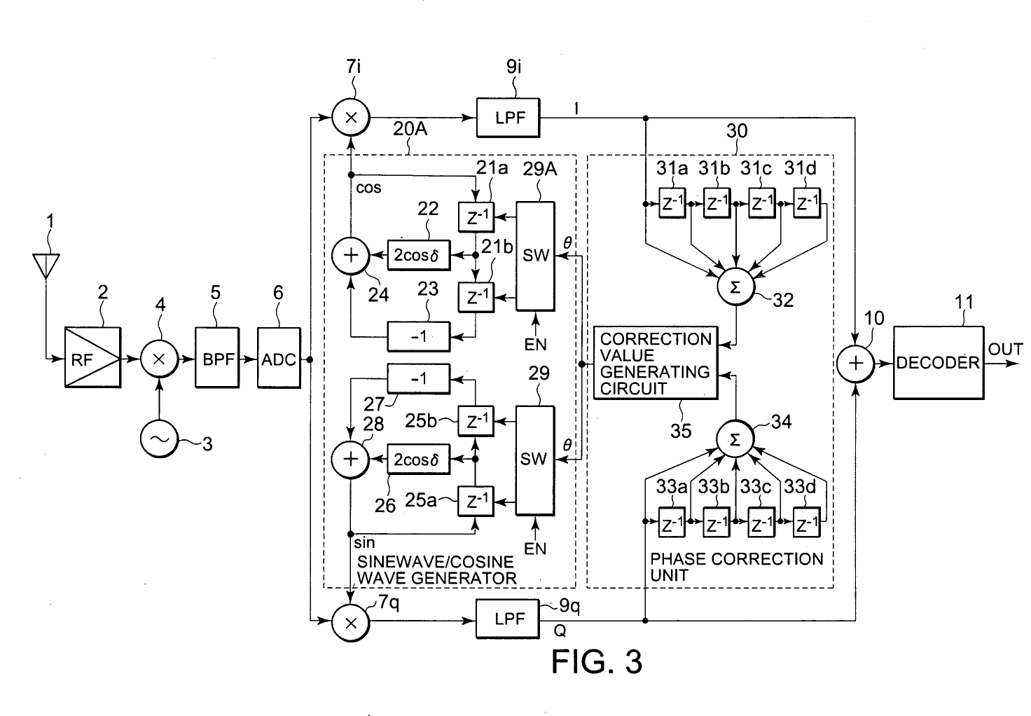

(6) As shown in a demodulation system of FIG. 3 according to an modification of the present invention, a cosine wave generating unit of a sine wave/cosine wave generator 20A may be configured in a manner similar to a sine wave generating unit in such a manner that a correction value θ outputted from a phase correction unit 30 is set to shift registers 21a and 21b via a switch 29A as an initial value.

What is claimed is:

1. A demodulation system that modulates orthogonal carriers with first and second data signals respectively and demodulates a combined phase-modulated signal, said demodulation system comprising:
carrier generating means that generates first and second demodulating carriers identical in frequency to the carriers and controlled in phase difference according to a correction value in order to demodulate the phase-modulated signal;
first demodulating means that multiplies the phase-modulated signal by the first demodulating carrier to demodulate an inphase component;
second demodulating means that multiplies the phase-modulated signal by the second demodulating carrier to demodulate an antiphase component; and
phase correcting means that generates the correction value equivalent to a phase error received from each of a propagation path and an internal circuit, based the inphase component and the antiphase component and supplies the same to the carrier generating means.

2. A demodulation system that modulates orthogonal carriers with first and second data signals respectively and demodulates a combined phase-modulated signal, said demodulation system comprising:
carrier generating means that generates first and second demodulating carriers identical in frequency to the carriers and controlled in phase difference according to a correction value in order to demodulate the phase-modulated signal;
first demodulating means that multiplies the phase-modulated signal by the first demodulating carrier to demodulate an inphase component;
second demodulating means that multiplies the phase-modulated signal by the second demodulating carrier to demodulate an antiphase component;
phase correcting means that generates the correction value so as to align a reference phase of either of the inphase component and the antiphase component or reference phases of both thereof with an actual phase error and supplies the same to the carrier generating means;
a decoder that decodes the first and second data signals from the inphase component and the antiphase component; and
control means that stops the operation of the phase correcting means when error rates of the decoded first and second data signals reach a reference value or less.

3. A demodulation system comprising:
a phase correction circuit that detects a phase shift in inphase component to generate a first correction value and detects a phase shift in orthogonal component to generate a second correction value;
a carrier generator that generates a first carrier, based on the first correction value and generates a second carrier, based on the second correction value;
a first demodulation circuit that multiplies a received signal by the first carrier and extracts a low band component to thereby generate the inphase component;
a second demodulation circuit that multiplies the received signal by the second carrier and extracts a low band component to thereby generate the orthogonal component; and
a synthetic circuit that combines the inphase component and the orthogonal component to generate a baseband signal.
